(19) United States
(12) Patent Application Publication
(10) Pub. No.: US 2025/0294433 A1
(43) Pub. Date: Sep. 18, 2025

(54) NETWORK DATA ANALYTICS FUNCTION SLICE LOAD ENHANCEMENT

(71) Applicant: AT&T Intellectual Property I, L.P., Atlanta, GA (US)

(72) Inventors: Mohamed Khalil, Murphy, TX (US); Farooq Bari, Kirkland, WA (US); Rohit Abhishek, Dawsonville, GA (US)

(21) Appl. No.: 18/608,434

(22) Filed: Mar. 18, 2024

(51) Int. Cl. H04W 48/16; H04W 60/00

(52) U.S. Cl. CPC H04W 48/16; H04W 60/00

(57) ABSTRACT

A processing system may obtain a network function profile registration from a first network function of a communication network and maintain a network function profile of the first network function in accordance with the network function profile registration, where for at least a first network slice serviced by the first network function, the network function profile associates network slice load information of the first network slice at the first network function and at least one identifier of the first network slice. The processing system may then obtain a network function profile update of the first network function, including first network slice load information of the first network slice and the at least one identifier of the first network slice, update the network function profile in accordance with the network function profile update, and provide, to a recipient network function, network function profile information in accordance with the network function profile.

The present disclosure relates generally to wireless communication networks, and more particularly to methods, non-transitory computer-readable media, and apparatuses for updating a network function profile of a first network function in accordance with a network function profile update that includes first network slice load information of a first network slice and at least one identifier of the first network slice, and to methods, non-transitory computer-readable media, and apparatuses for computing a predicted network slice load associated with a first network function for a first network slice based on first network slice load information obtained from a network repository function.

### BACKGROUND

A cloud radio access network (RAN) is part of the 3rd Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. 5G is intended to deliver superior high speed and performance. However, during initial deployments, 5G may potentially suffer from limited coverage areas, higher costs of deployment, slow rollout, and more costly initial subscription plans.

### SUMMARY

In one example, the present disclosure discloses a method, computer-readable medium, and apparatus for updating a network function profile of a first network function in accordance with a network function profile update that includes first network slice load information of a first network slice and at least one identifier of the first network slice. For example, a processing system including at least one processor may obtain a network function profile registration from a first network function of a communication network and may maintain a network function profile of the first network function in accordance with the network function profile registration, where for at least a first network slice serviced by the first network function, the network function profile of the first network function associates network slice load information of the first network slice at the first network function and at least one identifier of the first network slice. The processing system may then obtain a network function profile update of the first network function, the network function profile update including first network slice load information of the first network slice and the at least one identifier of the first network slice, update the network function profile of the first network function in accordance with the network function profile update, and provide, to a recipient network function, the network function profile information of the first network function in accordance with the network function profile.

In addition, in one example, the present disclosure discloses a method, computer-readable medium, and apparatus for computing a predicted network slice load associated with a first network function for a first network slice based on first network slice load information obtained from a network repository function. For example, a processing system including at least one processor may obtain first network function profile information of at least a first network function from a network repository function, the network function profile information including first network slice load information of a first network slice that is serviced by the first network function and at least one identifier of the first network slice. The processing system may next compute at least one predicted network slice load associated with the at least the first network function for the first network slice, where the computing is based on at least the first network slice load information. The processing system may then provide, to a recipient network function, the at least one predicted network slice load associated with the at least the first network function for the first network slice.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example template of at least a portion of a network function profile in accordance with the present disclosure;

FIG. 3 illustrates a flowchart of an example method for updating a network function profile of a first network function in accordance with a network function profile update that includes first network slice load information of a first network slice and at least one identifier of the first network slice;

FIG. 4 illustrates a flowchart of an example method for computing a predicted network slice load associated with a first network function for a first network slice based on first network slice load information obtained from a network repository function; and

FIG. 5 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for updating a network function profile of a first network function in accordance with a network function profile update that includes first network slice load information of a first network slice and at least one identifier of the first network slice, and methods, computer-readable media, and apparatuses for computing a predicted network slice load associated with a first network function for a first network slice based on first network slice load information obtained from a network repository function. In particular, examples of the present disclosure provide specific procedures and guidelines to implement network slice load analytics, e.g., via various network functions (NFs), a network repository function (NRF), and/or a network data analytics function (NWDAF). To illustrate, NF load information may be obtained by an NRF from its constituent NF instances (e.g., one or more session management functions (SMFs), access management functions (AMFs), and/or user plane functions (UPFs)). In accordance with the present disclosure, an NRF may obtain NF per-slice load information of a network slice instance (NSI) from constituent NF instances. In addition, in one example, the per-slice load information collected by the NRF may be used for network slice load analytics, e.g., via an NWDAF.

To further illustrate, 3rd Generation Partnership Project (3GPP) Technical Standard (TS) 23.501 may define a network slice as “a logical network that provides specific network capabilities and network characteristics,” and a network slice instance (NSI) may be defined as “a set of Network Function instances and the required resources (e.g., compute, storage and networking resources) which form a deployed Network Slice.” In addition, per 3GPP TS 28.530, an end-to-end network slice may include three types of network segments: Radio Access Network (RAN), Transport Network (TN) and Core Network (CN). Furthermore, per 3GPP TS 23.388, an NRF may obtain load information from each NF, where the load information may comprise number in the range of 0 to 100, indicating a load from 0% to 100% of the capacity of the NF.

However, for network slicing, a communication network may have various components that support multiple logical components with certain performance capabilities, etc., where groups of these logical components may comprise respective network slice instances (NSIs). A network slice, or NSI, may be assigned a network slice instance identifier (NSI-ID). In addition, a network slice, or NSI, may be further identified by single network slice selection assistance information (S-NSSAI). For instance, the S-NSSAI may include a slice service type (SST) and a service differentiator (SD), where the SD may be used to distinguish among different network slices in the same communication network that may be of the same SST. It is further noted that network slice selection assistance information (NSSAI) may comprise a collection of S-NSSAIs. For instance, a user equipment (UE) may be served by up to eight unique slices. Thus, up to eight S-NSSAIs may be included in NSSAI reported by a UE to the network.

In one example, network function profile update messages (NFP Update) may be used for NFs to report per-slice load information, e.g., to an NRF. For instance, an NF may report the load(s) at the NF for one or more slices. In one example, the reporting may be in response to a request, e.g., from the NRF. Alternatively, or in addition, the NRF may subscribe to updates, e.g., for updates to a network function profile (NFProfile) of an NF and/or for updates to the per-slice load information of the NF for one or more slices. For instance, the updates may be sent by an NF to the NRF periodically, when the NFProfile has changed (e.g., when one or more component data elements thereof have changed), when one or more data elements (such as the per-slice load information for one or more network slices) have changed by more than a threshold amount, etc.

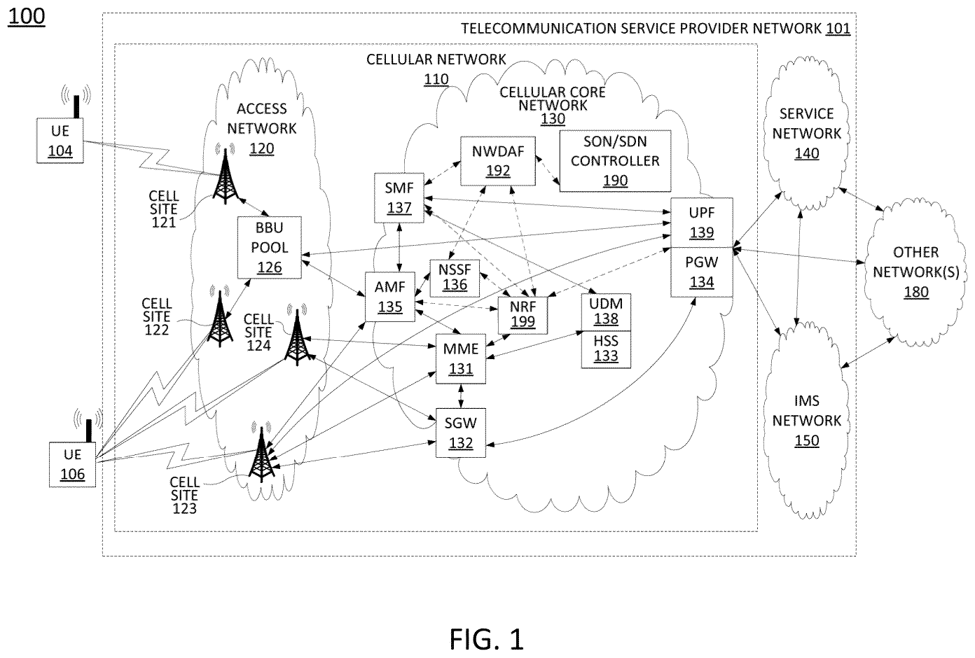

In addition, in one example, a network data analytics function (NWDAF) may obtain per-slice load information for one or more network slices associated with one or more NFs that may be gathered by the NRF. For instance, the NRF may report the per-slice load information for one or more network slices associated with one or more NFs periodically, when a network function's NFProfile has changed (e.g., when one or more component data elements thereof have changed) and/or when the per-slice load information for one or more network slices associated with one or more NFs has changed, etc. In one example, the NWDAF may maintain per-slice load information for one or more network slices and for one or more NFs associated with the one or more network slices over a period of time. For instance, the NWDAF may generate and report various analytic metrics associated with per-slice network loads, such as computing and reporting composite metrics, e.g., averages, moving averages, etc., detecting and reporting anomalies, and so forth. In one example, the analytic metrics may include predicted/forecast metrics, such as future predicted per-slice loads, e.g., using a regression based prediction model based on past per-slice load information over a historic period of time, or the like. Similarly, the analytic metrics may be based upon application of historic per-slice load information as input(s) to one or more artificial intelligence (AI) and/or machine learning (ML)-based models. For instance, historical anomaly detection and reporting may be based upon one or more formulas and/or thresholding. However, future anomalies may be predicted via a machine learning model (MLM) that may be trained upon historic data (e.g., comprising slice-specific load information for a network slice and associated with one or more NFs of such network slice). In addition, in one example, the NWDAF may report various metrics, including slice-specific analytic metrics, to one or more requesting and/or subscribing network functions. For instance, a network slice selection function (NSSF) may obtain slice-specific analytic metrics from the NWDAF, which the NSSF may use for various purposes, such as assigning a UE to a particular network slice, assigning a bearer session to a particular network slice (e.g., where another bearer session for the same UE could be assigned to the same slice or to a different slice), etc. These and other aspects of the present disclosure are discussed in greater detail below in connection with the examples of FIGS. 1-5.

To better understand the present disclosure, FIG. 1 illustrates an example network, or system 100 in which examples of the present disclosure may operate. In one example, the system 100 includes a telecommunication service provider network 101. The telecommunication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the telecommunication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In one example, the BBU pool 126 may be located at distances as far as 20-80 kilometers or more away from the antennas/remote radio heads of cell sites 121 and 122 that are serviced by the BBU pool 126. It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN infrastructure may include distributed RRHs and centralized baseband units, a heterogeneous network may include cell sites where RRH and BBU components remain co-located at the cell site. For instance, cell site 123 may include RRH and BBU components. Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-123 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, a network data analytics function (NWDAF) 192, and a network repository function (NRF) 199.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In accordance with the present disclosure, SMF 137 may be required to utilize NRF 199 to discover UPF instances in accordance with UPF selection functionality of the SMF 137. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, telecommunication service provider network 101 may provide a cloud storage service, web server hosting, and other services. As such, service network 140 may represent aspects of telecommunication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, NRF 199, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular core network 130 may also include a self-optimizing network (SON)/software defined network (SDN) controller 190. In one example, SON/SDN controller 190 may function as a self-optimizing network (SON) orchestrator that is responsible for activating and deactivating, allocating and deallocating, and otherwise managing a variety of network components. For instance, SON/SDN controller 190 may activate and deactivate antennas/remote radio heads of cell sites 121 and 122, respectively, may allocate and deactivate baseband units in BBU pool 126, and may perform other operations for activating antennas based upon a location and a movement of an endpoint device or a group of endpoint devices, in accordance with the present disclosure.

In one example, SON/SDN controller 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SON/SDN controller 190 may be connected directly or indirectly to any one or more network elements of cellular core network 130, and of the system 100 in general. Due to the relatively large number of connections available between SON/SDN controller 190 and other network elements, none of the actual links to the SON/SDN controller 190 are shown in FIG. 1. Similarly, intermediate devices and links between MME 131, SGW 132, cell sites 121-124, PGW 134, AMF 135, NSSF 136, SMF 137, UDM 138, NWDAF 192, NRF 199, and/or UPF 139, and other components of system 100 are also omitted for clarity, such as additional routers, switches, gateways, and the like.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

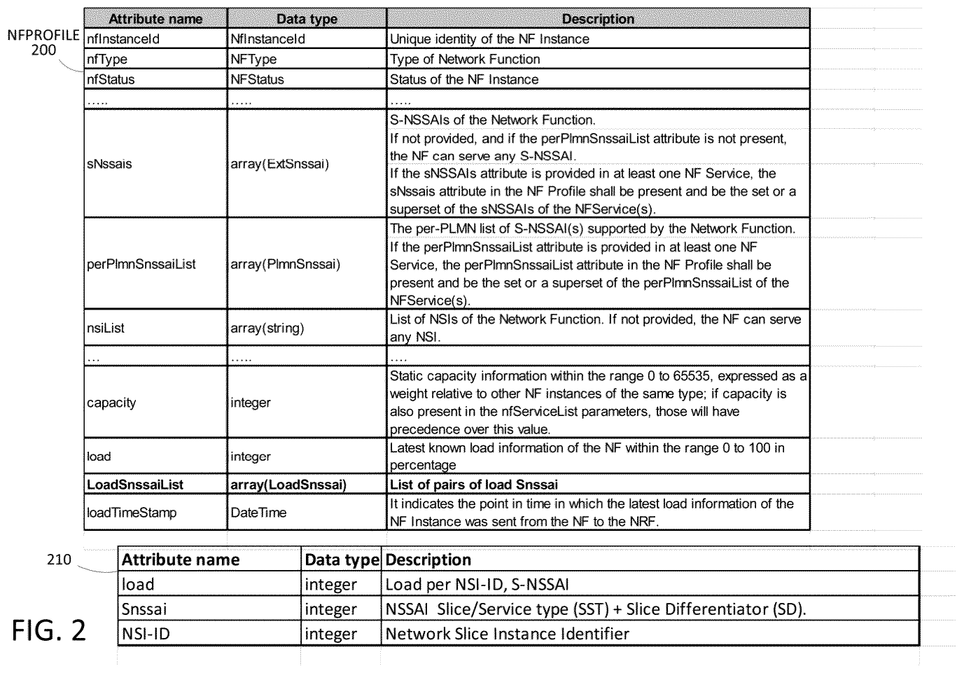

In one example, network functions (NFs), such as SMF 137, UPF 139, AMF 135, etc., may register with network repository function (NRF) 199. For instance, NRF 199 may maintain network function profiles (NFProfiles) for respective NFs, where each NFProfile may include a network function instance identifier, a network function type, a network function status, a network function instance name, a public land mobile network (PLMN) list associated with the NF, an array of S-NSSAIs supported by the NF, a list of NSIs supported by the network function, Internet Protocol addresses of the NF, a fully qualified domain name (FQDN) of the NF, and so forth. In accordance with the present disclosure, an NFProfile may further include slice-specific NF load information, e.g., a list/array of load levels experienced at the NF for each of one or more network slices supported by the NF, where each network slice may be identified by either or both of an S-NSSAI or an NSI-ID. In one example, an NFProfile may further include overall capacity and load information, per-slice capacity/allocation, and so forth. In any case, NRF 199 may maintain NFProfiles for registered NFs, the NFProfiles including per-slice load information for the respective NFs and the network slices supported by each respective NF. A portion of an example template for an NFProfile, including per-slice load information, is illustrated in FIG. 2 and described in greater detail below. In one example, the NFs may further transmit NFProfile updates, e.g., when information in an NF's NFProfile changes. For instance, in accordance with the present disclosure, an NF that experiences a change in load for one or more supported network slices may report the change(s)/new value(s) in one or more NFP Update messages to NRF 199.

In one example, other entities, e.g., other NFs, may also subscribe to receive NF profile updates/changes from NRF 199 for one or more NFs. In such case, NRF 199 may push updates/changes to the subscribed entities, e.g., when such updates/changes are received from reporting NFs, when a threshold number of such updates/changes are received from one or multiple reporting NFs, periodically and/or when a defined period of time has elapsed, e.g., without receiving a threshold number of updates/changes from reporting NF(s), etc. Alternatively, or in addition, NFs or other entities may request NFProfile information, e.g., all or a portion of an NFProfile, or multiple NFProfiles, in response to which the NRF 199 may provide the requested NFProfile information. To illustrate, in addition to reporting its own NFProfile information, SMF 137 may also request NFProfile information of other NFs from NRF 199. For instance, in accordance with the present disclosure, in one example it may be a requirement that UPF selection functionality shall utilize an NRF (e.g., NRF 199) to discover UPF instances (such as UPF 139 and others). In one example, per-slice load information from the UPF(s) network profile(s) may be used to select a UPF (and in one example one or more network slices thereof) to serve new protocol data unit (PDU) sessions, or the like for one or more UEs (e.g., UE 104 and/or UE 106 in the example of FIG. 1).

In addition, in one particular example, NWDAF 192 may subscribe to receive notification of updates to the NFProfile of an NF. Alternatively, or in addition, the NWDAF 192 (or other NFs) can make a specific request for the current NFProfile information for one or more NFs. The NWDAF 192 may then maintain network slice resource usage statistics, e.g., over a period of time, for a single network slice, or a set of network slices, for one or more network slices in one or more network zones, and so forth. In addition, using such per-slice load information for one or more NFs, NWDAF 192 may also make predictions, e.g., using various prediction/forecasting models, such as artificial intelligence (AI) and/or machine learning (ML) models, regression models, etc. For instance, NWDAF 192 may forecast/predict per-slice load at one or more NFs at one or more future time periods, may predict overall slice utilizations at one or more future time periods, may predict conflicts between networks slice demands at one or more network functions at one or more future time periods, and so forth.

In one example, other entities (e.g., other NFs or the like) may also utilize the NWDAF 192 to obtain network slice analytics (e.g., via specific requests and/or on a subscription basis) for various purposes. For example, NSSF 136 may obtain slice load level analytics which may be used by NSSF 136 to select a network slice or network slices to serve an endpoint device, or may indicate one or more network slices that are permitted to be selected to serve an endpoint device. For instance, as noted above, AMF 135 may query NSSF 136 for one or more network slices in response to a request from an endpoint device to establish a session to communicate with a PDN (e.g., which may be represented by other network(s) 180 in FIG. 1). The NSSF 136 may provide the selection to AMF 135, or may provide one or more permitted network slices to AMF 135, where AMF 135 may select the network slice from among the choices. In one example, AMF 135 may utilize additional information such as a UE/subscriber class or category from HSS 133. For example, when a slice is indicated to have a particular load level above a threshold, UEs/subscribers of one or more defined classes/categories may be prevented from accessing the slice, or may have preferential access to the slice over other classes/categories, and so forth.

It should be noted that the foregoing are only several illustrative examples and that other, further, and different examples may be further provided in accordance with the present disclosure. For instance, in another example, AMF 135 may subscribe to slice load level analytics from NWDAF 192, e.g., without NSSF 136 as an intermediary. In another example, AMF 135 may obtain NFProfile information from NRF 199, e.g., indicating the current/most recent slice load levels of one or more NFs, which AMF 135 may use for slice assignment/selection, etc. In still another example, SON/SDN controller 190 may subscribe to and/or may request NFProfile information from NRF 199. Alternatively, or in addition, SON/SDN controller 190 may subscribe to and/or may request slice load analytics from NWDAF 192. SON/SDN controller 190 may then perform various tasks in accordance with the NFProfile information and/or slice load analytics, such as instantiating new instances of one or more NFs (e.g., additional UPFs, additional SMFs, and/or additional AMFs, etc.), reconfiguring one or more NFs and/or the NFVI supporting such NFs (e.g., allocating more or less processor, memory, storage, and/or other resources of a host NFVI to a particular NFs, allocating more or less processor, memory, storage, and/or other resources of an NF to a particular slice, adding one or more new slices (network slice instance(s) (NSIs) and/or deactivating one or more existing slices/NSI(s), adding or removing support for a particular slice at one or more NFs, etc.), and so forth. Thus, these and other modifications, extensions, and/or alternate examples are all contemplated within the scope of the present disclosure.

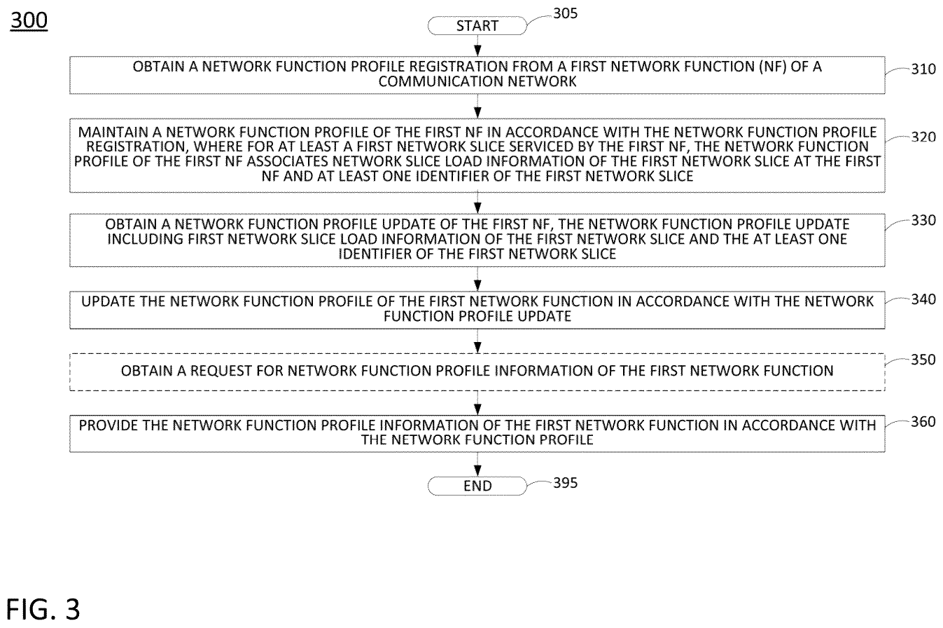

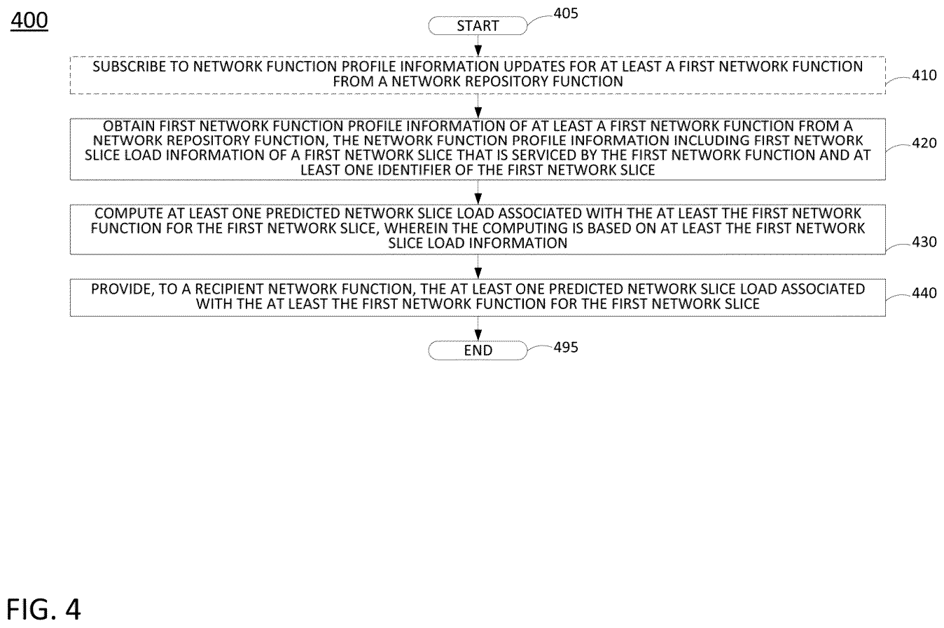

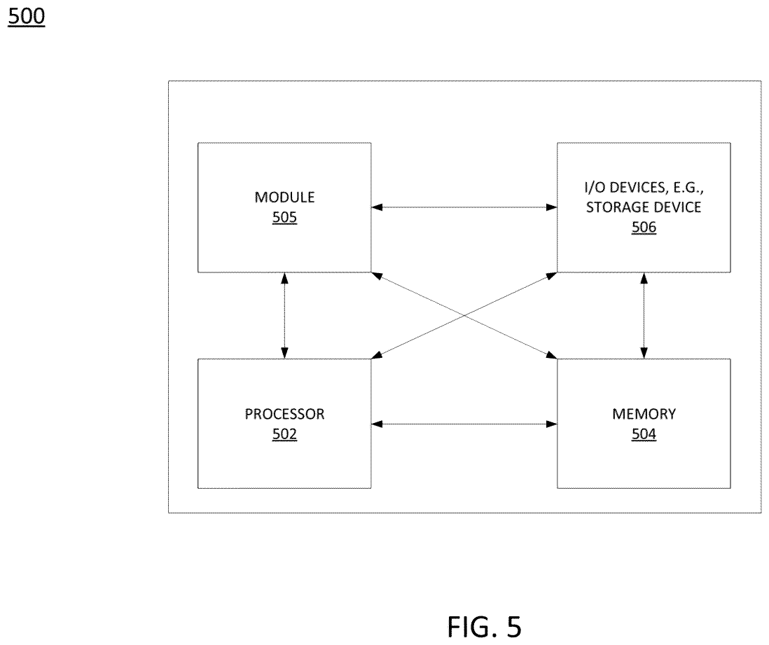

In one example, aspects of the present disclosure for updating a network function profile of a first network function in accordance with a network function profile update that includes first network slice load information of a first network slice and at least one identifier of the first network slice, e.g., as described in greater detail below in connection with the example method 300 of FIG. 3, may be performed by NRF 199. In this regard, in one example, NRF 199 may comprise all or a portion of a computing device or system, such as computing system 500, and/or processing system 502 as described in connection with FIG. 5 below, and may be configured to perform various operations in connection with examples of the present disclosure for updating a network function profile of a first network function in accordance with a network function profile update that includes first network slice load information of a first network slice and at least one identifier of the first network slice. Likewise, in one example, aspects of the present disclosure for computing a predicted network slice load associated with a first network function for a first network slice based on first network slice load information obtained from a network repository function, e.g., as described in greater detail below in connection with the example method 400 of FIG. 4, may be performed by NWDAF 192. In this regard, in one example, NWDAF 192 may comprise all or a portion of a computing device or system, such as computing system 500, and/or processing system 502 as described in connection with FIG. 5 below, and may be configured to perform various operations in connection with examples of the present disclosure for computing a predicted network slice load associated with a first network function for a first network slice based on first network slice load information obtained from a network repository function.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-123 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above. Thus, these and other modifications are all contemplated within the scope of the present disclosure.

FIG. 2 illustrates an example template of at least a portion of a network function profile (NFProfile) in accordance with the present disclosure. For example, the NFProfile template 200 includes a number of attributes (identified by attribute name), each of which may have a defined data type. In the example of FIG. 2, additional description of each of the example fields/attributes of NFProfile template 200 is provided in the third column. To illustrate in accordance with NFProfile template 200, an NFProfile of a given NF may include a network function instance identifier (nfInstanceId), a network function type (nfType) defining the type of the NF instance, a network function status (nfStatus), a list of SE-NSSAIs supported/served by the NF (sNssais), a list of per-PLMN S-NSSAIs supported by the NF (perPlmnSnssaiList), a list of NSIs served by the NF (nsiList), a capacity of the NF (capacity), a load of the NF (load), a load timestamp indicating the last time when the load information of the NF was updated (loadTimeStamp), and so forth. Additional aspects of an NFProfile, and NFProfile template 200 may be present but are omitted from FIG. 2 for ease of illustration, such as cardinality of the attribute data type, additional attributes, such as a fully qualified domain name (fqdn) of the NF, IPv4 and IPv6 address(es) of the NF, etc. In accordance with the present disclosure an NFProfile of the form of NFProfile template 200 may include an attribute/field for per-network slice load information, e.g., pairs of S-NSSAIs and respective load indicators). For instance, the attribute LoadSnssaiList may comprise an array of LoadSnssai data elements, e.g., array (LoadSnssai).

As further illustrated in FIG. 2, an example template 210 for a per-slice load information data element (LoadSnssai) includes three attributes: load, Snssai, and NSI-ID. Thus, in an NFProfile in accordance with the present disclosure, each LoadSnssai data element present in the LoadSnssai array associates a load with the corresponding network slice identified by S-NSSAI and/or NSI-ID. In one example, the load may be expressed as a value in the range of 0 to 100, indicating a load from 0% to 100% of the capacity of the NF that is dedicated to a particular network slice. It should be noted that FIG. 2 illustrates just one example of an NFProfile template 200 and a template 210 for a per-slice load information data element. Thus, in other, further, and different examples, an NFProfile and/or a per-slice load information data element may have a different form. For instance, in one example, an NFProfile may omit overall load information (e.g., the “load” attribute), where an overall load may be derived from aggregating the per-slice load information. In another example, a LoadSnssai data element may include just one of the S-NSSAI or NSI-ID, where these may be associated with one another via a table of NSI-IDs assigned to different S-NSSAIs, and so forth.

FIG. 3 illustrates a flowchart of an example method 300 for updating a network function profile of a first network function in accordance with a network function profile update that includes first network slice load information of a first network slice and at least one identifier of the first network slice, in accordance with the present disclosure. In one example, steps, functions and/or operations of the method 300 may be performed by a device as illustrated in FIG. 1, e.g., NRF 199, or any one or more components thereof, such as a processing system, or collectively via a plurality devices in FIG. 1, such as NRF 199 in conjunction with AMF 135, NSSF 136, SMF 137, UPF 139, and/or NWDAF 192, and so forth. In one example, the steps, functions, or operations of method 300 may be performed by a computing device or system 500, and/or a processing system 502 as described in connection with FIG. 5 below. For instance, the computing device 500 may represent at least a portion of NRF 199 in accordance with the present disclosure. For illustrative purposes, the method 300 is described in greater detail below in connection with an example performed by a processing system, such as processing system 502. The method 300 begins in step 305 and proceeds to step 310.

At step 310, the processing system obtains a network function profile registration from a first network function (NF) of a communication network. For instance, in one example, the processing system may be a processing system of a network repository function (NRF) and the first network function may comprise a user plane function (UPF), a session management function (SMF), an access management function (AMF), or the like. In one example, a transmission of the network function profile registration from the first network function to the processing system is a mandatory functionality of the first network function (e.g., from a UPF to an NRF).

At step 320, the processing system maintains a network function profile (e.g., an NFProfile) of the first network function in accordance with the network function profile registration (e.g., an NFP Registration message), where for at least a first network slice serviced by the first network function, the network function profile of the first network function associates network slice load information of the first network slice at the first network function with at least one identifier of the first network slice. For instance, the at least one identifier of the first network slice may comprise a single network slice selection assistance information (S-NSSAI) of the first network slice, a network slice instance identifier (NSI-ID) of the first network slice, or both. In one example, step 320 may comprise storing and/or creating a new network function profile, or a copy thereof, by the processing system (e.g., at the NRF).

At step 330, the processing system obtains a network function profile update (e.g., an NFP Update message) of the first network function, the network function profile update including first network slice load information of the first network slice and the at least one identifier of the first network slice. In one example, the obtaining of the network function profile update may include transmitting a network function profile update request to the first network function and receiving the network function profile update in response to the network function profile update request. In another example, the obtaining of the network function profile update may be in accordance with a reporting algorithm of the first network function. For instance, the first NF may report to the processing system on a periodic basis, when there is an update and/or when the load changes by more than a threshold amount, etc. In other words, the processing system may obtain the network function profile update via a request/response framework and/or via a subscribe/notify framework. However, the network function profile update may also be obtained in accordance with a default configuration of the NF, e.g., where the NF may automatically send network function profile updates when there is a change in the information and/or periodically.

At step 340, the processing system updates the network function profile of the first network function in accordance with the network function profile update. For instance, the processing system may change data/values for any attributes/fields having new or updated data for such attributes/fields indicated in the network function profile update that is obtained at step 330.

At optional step 350, the processing system may obtain a request for network function profile information of the first network function. For instance, the network function profile information may comprise all or a portion of the network function profile, e.g., at least the first network slice load information of the first network slice. For example, another network entity, e.g., another NF, may request per-slice load information for one or more slices supported by the NF. In one example, the network function profile information may further include at least one of: the single network slice selection assistance information of the first network slice or the network slice instance identifier of the first network slice. For instance, the request may indicate the desired per-slice load information by identifying the associated network slice(s). In one example, the request may be from a session management function (SMF). In addition, in such an example, the first network function for which the network function profile information is being requested may comprise a user plane function (UPF). For instance, in accordance with the present disclosure, an SMF may be required to utilize an NRF to discover UPF instances in accordance with UPF selection functionality of the SMF. In another example, the request may be from a network data analytics function (NWDAF). In one example, the request may pertain to more than one network slice and/or more than one NF.

At step 360, the processing system provides the network function profile information of the first network function in accordance with the network function profile. In one example, the providing of the network function profile information may be in response to a request that may be obtained at optional step 350. As noted above, in one example, the network function profile information may comprise all or a portion of the network function profile, e.g., at least the first network slice load information of the first network slice. In addition, in one example, the network function profile information may further include at least one of: the single network slice selection assistance information of the first network slice or the network slice instance identifier of the first network slice. It should be noted that in one example, the processing system may provide network function profile information in response to a specific request obtained at optional step 350. However, in another example, other NFs (such as NWDAF) may subscribe to receive notification of updates to the NFProfile of an NF. In such case, the processing system may provide the network function profile information automatically when there is a change in the information, periodically, etc. Following step 360, the method 300 may proceed to step 395 where the method ends.

It should be noted that the method 300 may be expanded to include additional steps or may be modified to include additional operations with respect to the steps outlined above. In one example, various steps of the method 300 may be repeated for the same or different network function. For instance, following step 360, the method 300 may return to step 320 and/or step 330 and may repeat steps 320 and/or 330 through step 360 to continue to maintain and update the network function profile, to provide such updated network function profile information to one or more requesting and/or subscribing entities on an ongoing basis, and so forth. In one example, the method 300 may be expanded or modified to include steps, functions, and/or operations, or other features described above in connection with the example(s) of FIGS. 1, 2, and/or 4, or as described elsewhere herein. Thus, these and other modifications are all contemplated within the scope of the present disclosure.

FIG. 4 illustrates a flowchart of an example method 400 for computing a predicted network slice load associated with a first network function for a first network slice based on first network slice load information obtained from a network repository function, in accordance with the present disclosure. In one example, steps, functions and/or operations of the method 400 may be performed by a device as illustrated in FIG. 1, e.g., NWDAF 192, or any one or more components thereof, such as a processing system, or collectively via a plurality devices in FIG. 1, such as NWDAF 192 in conjunction with AMF 135, NSSF 136, SMF 137, UPF 139, and/or NRF 199, and so forth. In one example, the steps, functions, or operations of method 400 may be performed by a computing device or system 500, and/or a processing system 502 as described in connection with FIG. 5 below. For instance, the computing device 500 may represent at least a portion of NWDAF 192 in accordance with the present disclosure. For illustrative purposes, the method 400 is described in greater detail below in connection with an example performed by a processing system, such as processing system 502. The method 400 begins in step 405 and may proceed to optional step 410 or step 420.

At optional step 410, the processing system may subscribe to network function profile information updates for at least a first network function from a network repository function. For instance, the first NF may comprise a UPF, an SMF, an AMF, or the like.

At step 420, the processing system obtains first network function profile information of at least a first network function from a network repository function, the network function profile information including first network slice load information of a first network slice that is serviced by the first network function and at least one identifier of the first network slice. For instance, as discussed above, the at least one identifier of the first network slice comprises a single network slice selection assistance information of the first network slice, a network slice instance identifier of the first network slice, or both. In one example, the first network function profile information may be obtained from the network repository function in accordance with the subscribing of optional step 410. In another example, step 420 may include transmitting a request for network function profile information of the first NF to the NRF and receiving the network function profile information from the NRF in response to the request.

At step 430, the processing system computes at least one predicted network slice load associated with the at least the first network function for the first network slice, wherein the computing is based on at least the first network slice load information. In one example, the computing of the predicted network slice load information at step 430 may be based upon a plurality of network slice load information for the first network slice associated with the at least the first network function, where the plurality of network slice load information includes the first network slice load information. In one example, the plurality of network slice load information may include network slice load information for the first network slice associated with the first network function that is obtained for multiple time instances over a period of time. For instance, the time instances may comprise smaller time periods within a longer time window over which data is collected that is then used for the prediction. Alternatively, or in addition, the plurality of network slice load information may include network slice load information for the first network slice associated with a plurality of network functions of a network slice instance of the first network slice that is obtained for one or more time instances. For instance, the predicted network slice load may be for the first NF or may be for all or a portion of the network slice that is serviced by a network slice instance comprising a plurality of NFs (e.g., including at least the first NF). As noted above, the predicted network slice load may be computed in accordance with one or more AI/ML models, where collected network slice load information may be applied as inputs and the output may comprise the predicted network slice load.

At step 440, the processing system provides, to a recipient network function, the at least one predicted network slice load associated with the at least the first network function for the first network slice. In one example, step 440 may be in response to a subscription from the recipient network function for the predicted network slice load, e.g., for network slice load analytics, which may include at least the predicted network slice load. Following step 440, the method 400 may proceed to step 495 where the method ends.

It should be noted that the method 400 may be expanded to include additional steps or may be modified to include additional operations with respect to the steps outlined above. In one example, various steps of the method 400 may be repeated for the same or different network function, for the same or different network slice, and so forth. For instance, following step 440, the method 400 may return to step 420 and may repeat steps 420-440 to obtain new network function profile information, compute new predicted network slice load(s)/analytics, provide the new network slice load(s) to one or more recipient network functions, and so forth. In one example, the method 400 may be expanded to further include obtaining a subscription request from the recipient network function for predicted network slice loads associated with the first network function and/or the first network slice. In one example, the method 400 may further include training an AI and/or ML model using collected network slice load information as training data. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not specifically specified, one or more steps, functions, or operations of the method 300 or the method 400 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 3 or FIG. 4 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 5 depicts a high-level block diagram of a computing device or processing system specifically programmed to perform the functions described herein. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for updating a network function profile of a first network function in accordance with a network function profile update that includes first network slice load information of a first network slice and at least one identifier of the first network slice and/or for computing a predicted network slice load associated with a first network function for a first network slice based on first network slice load information obtained from a network repository function, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 506 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 505 for updating a network function profile of a first network function in accordance with a network function profile update that includes first network slice load information of a first network slice and at least one identifier of the first network slice and/or for computing a predicted network slice load associated with a first network function for a first network slice based on first network slice load information obtained from a network repository function (e.g., a software program comprising computer-executable instructions) can be loaded into memory 504 and executed by hardware processor element 502 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for updating a network function profile of a first network function in accordance with a network function profile update that includes first network slice load information of a first network slice and at least one identifier of the first network slice and/or for computing a predicted network slice load associated with a first network function for a first network slice based on first network slice load information obtained from a network repository function (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor, a network function profile registration from a first network function of a communication network;
maintaining, by the processing system, a network function profile of the first network function in accordance with the network function profile registration, wherein for at least a first network slice serviced by the first network function, the network function profile of the first network function associates network slice load information of the first network slice at the first network function and at least one identifier of the first network slice;
obtaining, by the processing system, a network function profile update of the first network function, the network function profile update including first network slice load information of the first network slice and the at least one identifier of the first network slice;
updating, by the processing system, the network function profile of the first network function in accordance with the network function profile update; and
providing, by the processing system to a recipient network function, network function profile information of the first network function in accordance with the network function profile.

2. The method of claim 1, wherein the at least one identifier of the first network slice comprises at least one of:
a single network slice selection assistance information of the first network slice; or
a network slice instance identifier of the first network slice.

3. The method of claim 2, wherein the network function profile information comprises at least the first network slice load information of the first network slice.

4. The method of claim 3, wherein the network function profile information further comprises at least one of: the single network slice selection assistance information of the first network slice or the network slice instance identifier of the first network slice.

5. The method of claim 1, wherein the request is from a session management function.

6. The method of claim 5, wherein the first network function comprises a user plane function.

7. The method of claim 6, wherein the processing system comprises a processing system of a network repository function.

8. The method of claim 7, wherein a transmission of the network function profile registration from the first network function to the processing system is a mandatory functionality of the first network function.

9. The method of claim 1, wherein the request is from a network data analytics function.

10. The method of claim 1, wherein the obtaining of the network function profile update comprises:
transmitting a network function profile update request to the first network function; and
receiving the network function profile update in response to the network function profile update request.

11. The method of claim 1, wherein the obtaining of the network function profile update is in accordance with a reporting algorithm of the first network function.

12. The method of claim 1, further comprising:
obtaining a request for network function profile information of the first network function, wherein the providing of the network function profile information is in response to the request.

13. A non-transitory computer-readable medium storing instructions which, when executed by a processing system including at least one processor, cause the processing system to perform operations, the operations comprising:
obtaining a network function profile registration from a first network function of a communication network;
maintaining a network function profile of the first network function in accordance with the network function profile registration, wherein for at least a first network slice serviced by the first network function, the network function profile of the first network function associates network slice load information of the first network slice at the first network function and at least one identifier of the first network slice;
obtaining a network function profile update of the first network function, the network function profile update including first network slice load information of the first network slice and the at least one identifier of the first network slice;
updating the network function profile of the first network function in accordance with the network function profile update; and
providing, to a recipient network function, network function profile information of the first network function in accordance with the network function profile.

14. A method comprising:
obtaining, by a processing system including at least one processor, first network function profile information of at least a first network function from a network repository function, the network function profile information including first network slice load information of a first network slice that is serviced by the first network function and at least one identifier of the first network slice;
computing, by the processing system, at least one predicted network slice load associated with the at least the first network function for the first network slice, wherein the computing is based on at least the first network slice load information; and
providing, by the processing system to a recipient network function, the at least one predicted network slice load associated with the at least the first network function for the first network slice.

15. The method of claim 14, wherein the at least one identifier of the first network slice comprises at least one of:
a single network slice selection assistance information of the first network slice; or
a network slice instance identifier of the first network slice.

16. The method of claim 14, wherein the computing of the predicted network slice load information is based upon a plurality of network slice load information for the first network slice associated with the at least the first network function, wherein the plurality of network slice load information includes the first network slice load information.

17. The method of claim 16, wherein the plurality of network slice load information comprises network slice load information for the first network slice associated with the first network function that is obtained for multiple time instances over a period of time.

18. The method of claim 16, wherein the plurality of network slice load information comprises network slice load information for the first network slice associated with a plurality of network functions of a network slice instance of the first network slice that is obtained for one or more time instances.

19. The method of claim 14, further comprising:
subscribing to network function profile information updates for the at least the first network function from the network repository function, wherein the first network function profile information is obtained from the network repository function in accordance with the subscribing.

20. The method of claim 14, wherein the first network function comprises:
a user plane function;
a session management function; or
an access management function.
